(19) United States
(12) Patent Application Publication
(10) Pub. No.: US 2026/0089150 A1
(43) Pub. Date: Mar. 26, 2026

(54) CERTIFICATE AUTO-RENEWAL USING PROXY DEVICE

(71) Applicant: CISCO TECHNOLOGY, INC., San Jose, CA (US)

(72) Inventors: Pranetha Priya R, Tamil Nadu (IN); Frank Michaud, ROLLE (CH); Nivetha B, Tamil Nadu (IN); Rahul Kata, Karnataka (IN); Ganesh Paramasivan, Karnataka (IN)

(21) Appl. No.: 18/895,224

(22) Filed: Sep. 24, 2024

(51) Int. Cl. H04L 9/40

(52) U.S. Cl. CPC H04L 63/0823

(57) ABSTRACT

Methods, systems and computer programs products are provided for renewing a digital certificate. A method includes: providing a trust model that defines a chain of trust among computing devices in an enterprise environment; determining, by a processor, that at least one of the computing devices is at least one of unavailable and unreachable; determining, by the processor, a proxy device from the computing devices based on the trust model; obtaining, by the processor, a temporary digital certificate from the proxy device; and storing, by the processor, the temporary digital certificate to perform future authentications.

### TECHNICAL FIELD

The present disclosure relates to authentication of digital certificates, and more particularly to methods, systems and computer program products for authentication of digital certificates using a proxy device.

### BACKGROUND

A certificate authority is an entity or device used to issue digital certificates that are subsequently used to confirm the legitimacy of websites, devices, individuals, and more. An automatic certificate management environment (ACME) protocol is a communication protocol for automating interactions between certificate authorities and other devices associated with the digital certificates.

Some large enterprises maintain a large number of secured components including intranet sites, virtual private networks, device identification, secure communications between internal services and interoperable communications for third parties, including containerized or API-connected cloud environments. These enterprises may opt to establish their own internal certificate authority, referred to as a private certificate authority that creates internal root certificates which can issue other private certificates for internal servers and users. In such case, the enterprise is held as the ultimate source of truth for deciding which devices, users or processes are trusted inside the network. The enterprise may manage hundreds of digital certificates for different applications.

Each digital certificate typically has an associated expiration date and when expired, the connectivity to the certificate authority is lost. In such case, the authentication fails and can cause products to stop working or work in a downgraded way. Tracking the expiration of the digital certificate can be difficult to manage.

Accordingly, it is desirable to provide methods, systems, and computer program products for managing authentication of digital certificates in an enterprise environment. These features and other desirable features will become apparent from the present disclosure and accompanying drawings.

### BRIEF DESCRIPTION OF THE DRAWINGS

In order that the disclosure may be well understood, there will now be described various forms thereof, given by way of example, reference being made to the accompanying drawings, in which:

FIG. 1 is a functional block diagram illustrating an enterprise having a digital certificate renewal system in accordance with various embodiments;

FIG. 2 is a function block diagram illustrating exemplary computing devices having the digital certificate renewal system in accordance with various embodiments; and

FIGS. 3, 4 and 5 are process flowcharts illustrating a process of renewing a digital certificate using a proxy device as performed by the digital certificate renewal system in accordance with various embodiments.

### DESCRIPTION OF EXAMPLE EMBODIMENTS

The following description is merely exemplary in nature and is not intended to limit the present disclosure, application, or uses. It should be understood that throughout the drawings, corresponding reference numerals indicate like or corresponding parts and features.

### Overview

Methods, systems and computer programs products are provided for renewing a digital certificate. A method includes: providing a trust model that defines a chain of trust among computing devices in an enterprise environment; determining, by a processor, that at least one of the computing devices is at least one of unavailable and unreachable; determining, by the processor, a proxy device from the computing devices based on the trust model; obtaining, by the processor, a temporary digital certificate from the proxy device; and storing, by the processor, the temporary digital certificate to perform future authentications.

### Example Embodiments

In accordance with the present disclosure, an enterprise is described that establishes a trust model and authenticates, revokes, and/or renews digital certificates using a protocol that includes cross-trust among devices. As will be discussed, this cross-trust enables the use of a proxy device to be used when a certificate authority is unreachable during certificate renewal.

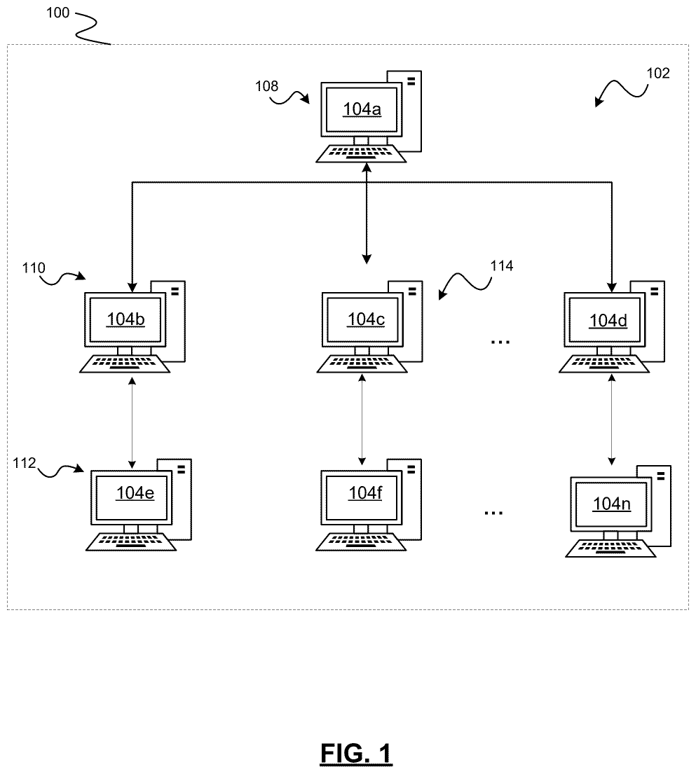

With reference now to FIG. 1, an exemplary enterprise environment 100 is shown having a digital certificate renewal system 102 in accordance with various embodiments. The enterprise environment 100 includes any number of computing devices 104a-104n communicatively coupled via a network. As can be appreciated, the computing devices 104a-104n can be coupled according to any number of network topologies. The topology shown illustrates a hierarchy that is used to establish a chain of trust within a trust model and is not necessarily the topology of the network.

In various embodiments, the computing devices 104 within the enterprise environment 100 include a first device designated as the certificate authority (CA) device 108, one or more intermediary devices coupled to the CA device 108 and designated as subordinate devices 110, and one or more end devices 112 coupled to the one or more subordinate devices 110. The trust model and the chain of trust starts with a root digital certificate that is self-signed by the CA device 108 and used to sign or approve of all subordinate devices 110 below it. The signed certificates of the subordinate devices 110 are, in turn, used to sign the end devices 112 below the subordinate devices 110, or additional subordinate devices 110, and/or used to sign the ultimate end entity certificates. If the certificate is signed and approved at the CA device 108, the entire chain of trust is verified and can be relied upon by the end devices 112.

In various forms, the digital certificate renewal system 102 is distributed across the computing devices 104, in particular, across the CA device 108, the subordinate device(s) 110, and/or the end device(s) 112, in order to manage the renewal of expired (or about to expire) digital certificates when one or more of the computing devices 104a-104n in the chain of trust become unavailable (e.g., a down or offline computing device 104a-104n) or unreachable (e.g., the network connection to the computing device 104a-104n is down or offline).

In various embodiments, the certificate renewal system 102 is configured to identify when the CA device 108 or a subordinate device 110 is unavailable or unreachable for renewing a digital certificate according to the trust model and, in response, manage the determination of a proxy device 114 from the other computing devices 104a-104n. The proxy device 114, once elected, is configured to include the renewal and revocation features of the CA device 108. This provides the proxy device 114 with the ability to sign off on a temporary certificate on behalf of the subordinate device 110 and/or the CA device 108 and to vouch or attest for the end device 112 with the expired (or about to expire) digital certificate.

In various embodiments, the proxy device 114 can be selected based on a static selection process, for example, by a nomination by an administrator of the enterprise who deems the device trustworthy (e.g., setting the device as a trust node). Additionally, or alternatively, the proxy device 114 can be selected by a dynamic election process conducted among trusted neighbor computing devices 104a-104n. As such, the digital certificate renewal system 102 maintains a certificate chain of trust under the trust model with more flexibility while ensuring reliability and provides temporary digital certificates that can be used for future authentications.

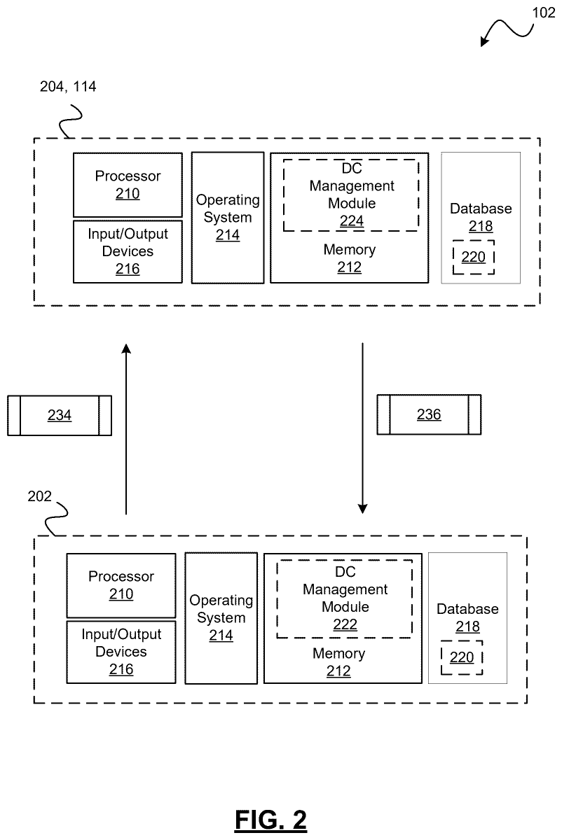

With reference now to FIG. 2, a dataflow diagram illustrates the digital certificate renewal system 102 being distributed between at least two computing devices, for example, an end device 202 and a subordinate device 204, in accordance with various embodiments. Each of the computing devices 202, 204 generally operates with any sort of conventional processing hardware, including, but not limited to, at least one processor 210, memory 212, an operating system 214, an input/output device 216, and/or a database 218 that stores enterprise data including digital certificate data 220. As can be appreciated, the processing hardware and/or configurations of the devices 202, 204 may differ from each other in various forms however, for ease of the discussion the devices 202, 204 will be discussed in terms of their general components.

In various embodiments, the processor 210 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 212 represents any non-transitory short-or long-term storage or other computer-readable media capable of storing programming instructions for execution on the processor 210, including any sort of random access memory (RAM), read only memory (ROM), flash memory, magnetic or optical mass storage, and/or the like. The computer-executable programming instructions, when read and executed by the processor 210, cause the processor 210 to create, generate, or otherwise facilitate the management of digital certificates and perform one or more additional tasks, operations, functions, and/or processes described herein. As can be appreciated, the memory 212 represents one suitable implementation of such computer-readable media, and alternatively or additionally, the processor 210 can receive and cooperate with external computer-readable media that is realized as a portable or mobile component or application platform, e.g., a portable hard drive, a USB flash drive, an optical disc, or the like.

The operating system 214 includes computer-executable programming instructions, when read and executed by the processor 210, cause the processor 210 to operate the device's basic functions such as scheduling tasks, executing applications, memory allocation, and controlling the input/output devices 216. The input/output devices 216 generally represents the interface(s) to networks, mass storage, display devices, data entry devices, and/or the like.

In various embodiments, the digital certificate renewal system 102 includes a digital certificate management module 222 stored in the memory 212 and executed by the processor 210 of the end device 202 and a digital certificate management module 224 stored in the memory 212 and executed by the processor 210 on the subordinate device 204. As can be appreciated, various exemplary embodiments of the digital certificate renewal system 102, according to the present disclosure, may include any number of modules and/or sub-modules implemented on any number of the computing devices 104a-104n (FIG. 1) in the enterprise environment 100. In various exemplary embodiments, the digital certificate management modules 222, 224 shown in FIG. 2 may be combined and/or further partitioned to similarly perform the renewal of digital certificates.

For example, the digital certificate management module 222 is configured to manage a renewal of a digital certificate by communicating messages 234 including a request to renew to the digital certificate management module 224. The digital certificate management module 222 is further configured to manage the renewal of the digital certificate by determining the subordinate device 204 to be the proxy device 114 by communicating messages 234 to the digital certificate management module 224 of the subordinate device 204 and the digital certificate management module 224 of other devices (not shown) as disclosed in the processes herein.

In another example, the digital certificate management module 224 is configured to receive the messages 234 and participate in the election by communicating messages 236 back to the digital certificate management module 222 and the digital certificate management module 222 of other devices (not shown) as disclosed in the processes herein. The digital certificate management module 224 is further configured to, once elected as the proxy device 114, perform the renewal and revocation of the digital certificate by communicating messages 236 to the digital certificate management module 222 of the end device 202 and the digital certificate management module 222 of other devices (not shown) as disclosed in the processes herein.

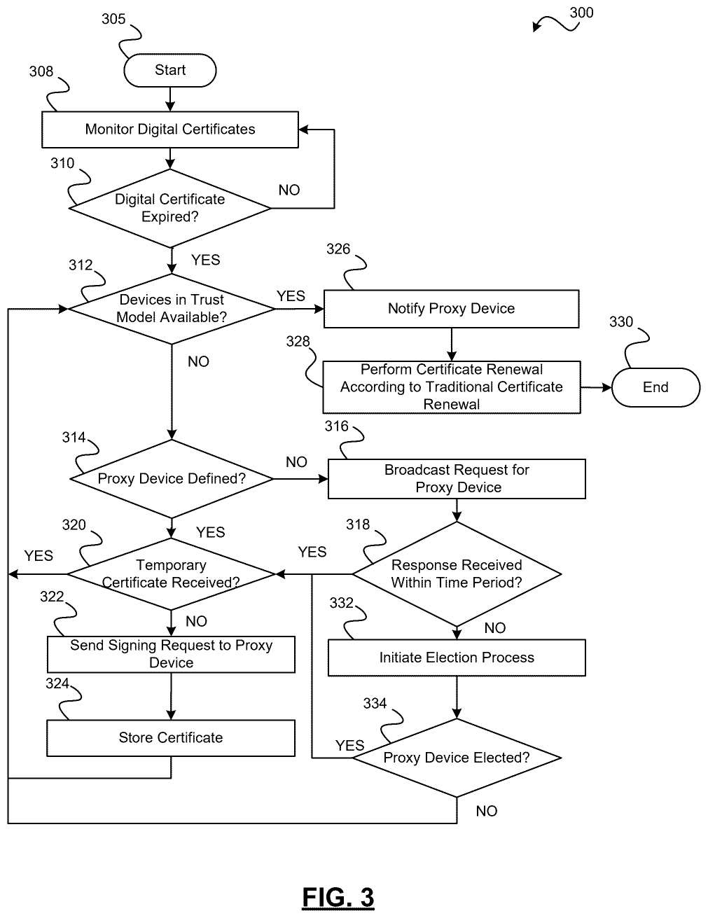

With reference now to FIGS. 3-5 and with continued reference to FIGS. 1-2, process flowcharts illustrate example processes 300, 400, 500 for renewing digital certificates using a proxy device 114 and the trust model in accordance with various embodiments. As can be appreciated in light of the disclosure, the order of operations performed by the processes 300, 400, and 500 is not limited to the sequential execution as illustrated in FIGS. 3-5 but may be performed in one or more varying orders as applicable and in accordance with the present disclosure. In various embodiments, the processes 300, 400, and 500 can be scheduled to run based on one or more predetermined events or run automatically based on an occurrence of one or more events.

In various embodiments, the process 300 may be performed by the digital certificate management module 222 of the end device 202 of FIG. 2 (or the end device 112 of FIG. 1) in order to renew an expired (or about to expire) digital certificate. For example, the process 300 may begin at 305. The digital certificates of the end device 112 are monitored at 308. When the end device recognizes that a digital certificate is expired or is about to expire at 310 and recognizes that a subordinate device and/or the CA device in the trust model is unavailable or unreachable at 312, it is determined whether the proxy device 114 is already defined at 314. If the proxy device 114 is not defined at 314, a broadcast message is sent to neighboring devices to determine if there is a proxy device already present (e.g., via either the static selection process or a previous dynamic election process) at 316.

If the proxy device 114 is already defined at 314 or if the proxy device 114 responds within a time period at 318, it is determined whether the request is successful, and a temporary certificate is received at 320. If the temporary certificate is received at 320, the process 300 continues at 312. If, however, the temporary certificate is not received at 320, a pseudo certificate signing request is sent to the proxy device 114 at 322. The proxy device 114 will have available limited capabilities of the CA device and can issue a temporary renewal certificate, the temporary renewal certificate is stored at 324.

With the temporary renewal in place, the process 300 continues with checking the devices of the trust model at intervals for availability for the traditional certificate renewal process at 312. When the subordinate device or the device becomes available or reachable, the proxy device 114 is notified at 326, the proxy-related information is deleted, and each node shall delete the local trust chain. The process proceeds with renewing the digital certificate through the subordinate device and the CA device according to the traditional certificate renewal process at 328. Thereafter, the process 300 may end at 330.

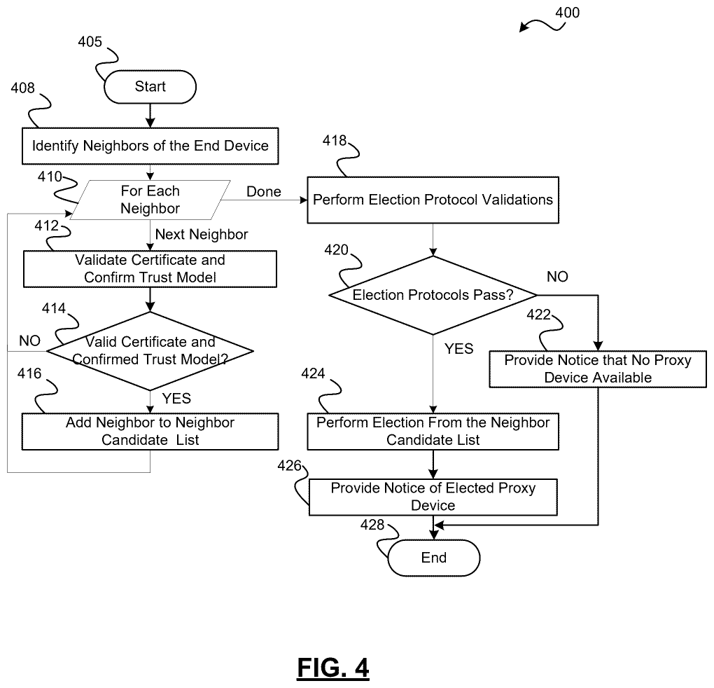

At 314, if a proxy device 114 is not defined and no response is received within a period of time at 318, the dynamic election process is initiated at 332, for example as discussed with regard to FIG. 4, to elect the proxy device 114.

If no proxy device is elected at 334, the process 300 continues with checking the devices of the trust model at intervals for availability for the traditional certificate renewal process at 312.

If, however, the proxy device 114 is elected at 334, it is determined whether the request is successful, and a temporary certificate is received at 320. If the temporary certificate is received at 320, the process 300 continues at 312. If, however, the temporary certificate is not received at 320, a pseudo certificate signing request is sent to the proxy device 114 at 322. The proxy device 114 will have available limited capabilities of the CA device and can issue a temporary renewal certificate, the temporary renewal certificate is stored at 324.

With the temporary renewal in place, the process 300 continues with checking the computing devices of the trust model at intervals for availability for the traditional certificate renewal process at 312. When the computing device becomes available or reachable, the proxy device 114 is notified at 326 and the process proceeds with renewing the digital certificate through the subordinate device and the CA device according to the traditional certificate renewal process at 328. Thereafter, the process 300 may end at 330.

FIG. 4 illustrates a process 400 for conducting the election process that may be performed by the end device 202 at, for example, step 332 of the process 300 of FIG. 3. For example, the process 400 may begin at 405. Neighbor computing devices of the end device are identified at 408. For each neighbor computing device at 410, verification of the neighbor's certificate is performed, and the trust model is confirmed at 412. If the certificate is valid and the neighbor computing device shares the same trust model, the neighbor computing device is added to a neighbor candidate list at 416.

Once the identified neighbor computing devices are evaluated and the neighbor candidate list is complete at 410, election protocol validations are performed at 418. For example, computing devices in the neighbor candidate list will try contacting the unavailable or unreachable computing device in the chain of trust to confirm whether computing device is unavailable or unreachable and provide indication of the confirmation. If it is indicated that the computing device is reachable and available, the election request is dismissed.

If, at 420, the election protocols do not pass, notice is provided that a proxy device has not been elected at 422. Thereafter, the process 400 may end at 428.

If the election protocols pass at 420, the election is performed and a neighbor computing device from the neighbor candidate list is elected as the proxy device 114 at 424. In various embodiments, the election can be performed based on election criteria that evaluates parameters of each neighbor computing device and/or of their respective digital certificates. Such parameters can include, but are not limited to, a length of certificate expiry (e.g., a neighbor with a longest certificate expiry), a length of uptime (e.g., the longest uptime of the computing device), etc.

In various embodiments, the election criteria can be based on a proof-of-stake (POS) established by each neighbor computing device that is used to weight the votes. For example, device parameters can be used to establish the weights, such as but not limited to, a date of expiration of a digital certificate or other asset of the computing device.

In various embodiments, the election can be performed based on a known port number (e.g., a port number used to broadcast the request for a proxy device) so that all computing devices in the broadcast domain communicate with each other to elect the proxy device 114.

Once the election is complete, notice is provided indicating that the proxy device 114 has been elected at 426. Thereafter, the process 400 may end at 428.

In various embodiments, the dynamically elected proxy device 114 can include a time-sensitive token to indicate the duration up to which it will have the capability to sign off other certificates. Once the token is expired, all relevant information, including but not limited to the local trust chain, is deleted.

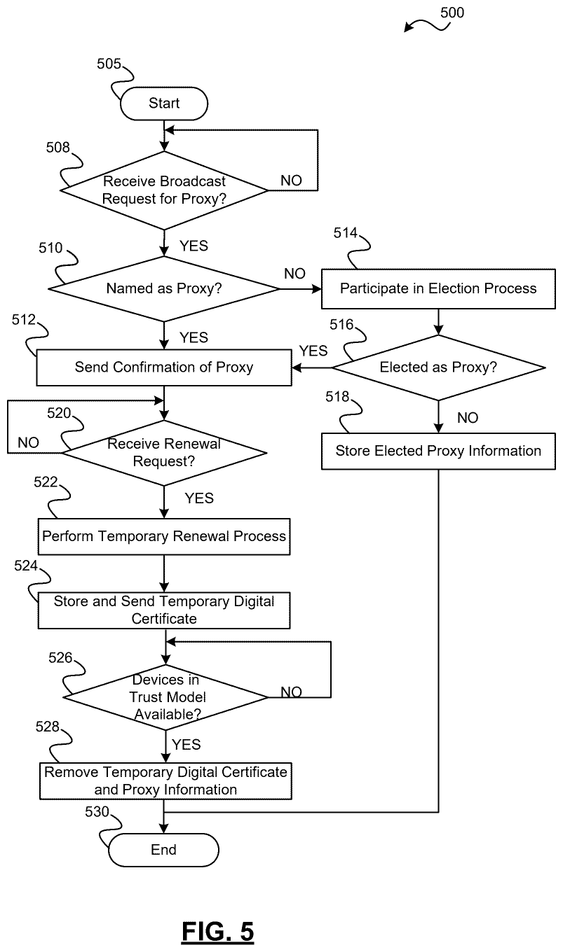

FIG. 5 illustrates a process 500 for participating in the election process and generating the temporary renewal certificate as performed by the module 222 of the device 202 that is elected as the proxy device 114. For example, the process 500 may begin at 505. It is determined whether a request for a proxy device 114 is received at 508. If a request for the proxy device 114 is not received at 508, the process 500 may end at 526. If a request for a proxy device 114 is received at 508, it is determined whether the computing device is already named as the proxy device 114 at 510. If the computing device is already named as the proxy device 114 at 510, a confirmation of the proxy and any proxy information is sent back to the requesting end device at 512.

If the device is not named as the proxy device 114 at 510, the election process is participated in, for example, by performing any validation requests at 514. If a notification is received that the computing device is the elected proxy at 516, the device is prepared to be the proxy and confirmation of the proxy is sent to the end device 112 at 512. For example, a certificate with a new keypair is created and self-signed such that it can be used to sign-off other digital certificates. The self-signed certificate is then published to all the computing devices in the trust model such that it may be stored, and tagged as the trusted proxy device 114, thus creating its own local trust chain.

At 516, if the computing device is not selected as the proxy device 114, the elected proxy information (e.g., including their self-signed certificate) is stored at 518.

At 520, upon receiving a digital certificate renewal request, a temporary certificate renewal process is performed to produce a temporary digital certificate at 522. For example, the digital certificate is signed off on after verifying with the self-signed certificate based on defined policies and/or checks. In various embodiments, the temporary digital certificate includes a namespace associated roles for mapping policies associated with the temporary digital certificate such as, but not limited to, duration, proxy flag (differentiates temporary certificates from others) and use policies. The temporary certificate, in turn, is stored and communicated to other computing devices in the trust model at 524 to be selectively signed off on, thus maintaining a local trust chain.

When messages are received that indicate the unavailable or unreachable device has become available or reachable at 526, the proxy information including the stored self-signed certificate and/or keypair, and/or the temporary digital certificate are deleted at 528 and each node shall delete the local trust model. Thereafter, the process 500 may end at 530.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for renewing a digital certificate, comprising:
providing a trust model that defines a chain of trust among computing devices in an enterprise environment;
determining, by a processor, that at least one of the computing devices is at least one of unavailable and unreachable;
determining, by the processor, a proxy device from the computing devices based on the trust model;
obtaining, by the processor, a temporary digital certificate from the proxy device; and
storing, by the processor, the temporary digital certificate to perform future authentications.

2. The method of claim 1, wherein the determining the proxy device is based on an election process among the computing devices.

3. The method of claim 2, wherein the election process is based on parameters associated with at least one of the computing devices, and digital certificates of the computing devices.

4. The method of claim 3, wherein the parameters include at least one of an uptime of the computing devices, and a length of expiry of the digital certificates.

5. The method of claim 2, wherein the election process is based on votes from the computing devices that are weighted.

6. The method of claim 2, wherein the election process is based on a defined communication port.

7. The method of claim 1, further comprising determining a candidate list based on computing devices that are neighbors.

8. The method of claim 7, wherein the determining the candidate list is based on an evaluation of a trust model of the computing devices that are neighbors.

9. The method of claim 7, wherein the determining the candidate list is based on a verification of digital certificates associated with the computing devices that are neighbors.

10. The method of claim 1, wherein the determining the proxy device is based on a nomination of one computing device of the computing devices of the trust model.

11. The method of claim 1, wherein the obtaining the temporary digital certificate is based on a certificate that is self-signed with a keypair of the proxy device.

12. A system for renewing a digital certificate, comprising:
one or more processors;
a computer-readable storage medium storing instructions which, when executed by the one or more processors, cause the one or more processors to:
store a trust model that defines a chain of trust among computing devices in an enterprise environment;
determine that at least one of the computing devices is at least one of unavailable and unreachable;
determine a proxy device from the computing devices based on the trust model;
obtain a temporary digital certificate from the proxy device; and
store the temporary digital certificate to perform future authentications.

13. The system of claim 12, wherein the instructions cause the one or more processors to determine the proxy device based on an election process among the computing devices.

14. The system of claim 13, wherein the election process is based on at least one of parameters associated with at least one of the computing devices, and digital certificates of the computing devices, votes from the computing devices that are weighted, and a defined communication port.

15. The system of claim 12, wherein the instructions cause the one or more processors to determine a candidate list based on computing devices that are neighbors.

16. The system of claim 15, wherein the instructions cause the one or more processors to determine the candidate list based on an evaluation of a trust model of the computing devices that are neighbors.

17. The system of claim 15, wherein the instructions cause the one or more processors to determine the candidate list based on a verification of digital certificates associated with the computing devices that are neighbors.

18. The system of claim 12, wherein the instructions cause the one or more processors to determine the proxy device based on a nomination of one computing device of the computing devices of the trust model.

19. The system of claim 12, wherein the instructions cause the one or more processors to obtain the temporary digital certificate based on a certificate that is self-signed with a keypair of the proxy device.

20. A computer-readable storage device storing instructions which, when executed by one or more processors, cause the one or more processors to:
store a trust model that defines a chain of trust among computing devices in an enterprise environment;
determine that at least one of the computing devices is at least one of unavailable and unreachable;
determine a proxy device from the computing devices based on the trust model;
obtain a temporary digital certificate from the proxy device; and
store the temporary digital certificate to perform future authentications.
